(19) United States
(12) Patent Application Publication
(10) Pub. No.: US 2025/0298878 A1
(43) Pub. Date: Sep. 25, 2025

(54) INTELLIGENT METHOD FOR LOGGING IN OPERATING SYSTEM AND SYSTEM

(71) Applicant: REALTEK SEMICONDUCTOR CORP., HSINCHU (TW)

(72) Inventors: SHI-HAO LI, HSINCHU (TW); PAO-CHI YEH, HSINCHU (TW)

(21) Appl. No.: 19/083,953

(22) Filed: Mar. 19, 2025

(30) Foreign Application Priority Data
Mar. 21, 2024 (TW) 113110423

(51) Int. Cl. G06F 21/32

(52) U.S. Cl. CPC G06F 21/32

(57) ABSTRACT

An intelligent method for logging in an operating system and a system are provided. In the method, a color camera is firstly activated to capture a color image in a booting procedure of the operating system. Brightness information is extracted from the color image, and is referred to for predicting a scene and a corresponding exposure setting by a scene prediction model. The exposure setting may be mapped to an infrared exposure setting when necessary. After that, an infrared camera is activated to generate an infrared image according to the infrared exposure setting. A biometric image in the infrared image having an appropriate exposure can be used to perform user identification. Therefore, the operating system can complete the user identification and a login process at a first infrared image.

### CROSS-REFERENCE TO RELATED PATENT APPLICATION

This application claims the benefit of priority to Taiwan Patent Application No. 113110423, filed on Mar. 21, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an operating system login method, and more particularly to an intelligent method for logging in an operating system through an image with an appropriate exposure based on a scene predicted by an intelligent model and a system thereof.

### BACKGROUND OF THE DISCLOSURE

Windows® Hello is a biometric technology that is incorporated into a Windows® 10 operating system when being launched in 2015. In a method for logging in the operating system by Windows® Hello, personal biometrics (such as fingerprints, facial features, or iris features) are used to replace a conventional password for processing user identification. Using the personal biometrics is not only convenient, but is also safer for logging in the operating system. Particularly, facial recognition is the most widely used login method of Windows® Hello.

The facial recognition method requires a user to face to a camera or an IR (infrared) depth camera. The operating system starts to scan the user's face and identify facial features of the user. The user can then login the operating system after the facial features are compared with preset samples. Apart from the above-mentioned login method, fingerprint identification and iris identification are two other methods for logging in the operating system. However, the fingerprint identification requires an additional fingerprint identification reader, and an iris reader is required for the iris identification. Even though the iris identification has a lowest false acceptance rate (FAR), the iris identification can be affected when the user wears glasses or circle contact lenses. It should be noted that the above-mentioned false acceptance rate indicates the possibility of a biometric identification system incorrectly recognizing an illegal user as a legal user.

Although the facial recognition technology of Windows® Hello is convenient and accurate in most situations, certain difficulties are still present. Particularly, various ambient lights may affect the accuracy of facial recognition. FIG. 1 is a schematic diagram showing auto-exposure convergence curves for various scenes under different ambient lights.

FIG. 1 shows curves of brightness convergence of continuous frames in a conventional auto-exposure procedure for different scenes (such as an outdoor scene, a back-light scene, a front-light scene, and an indoor scene).

For example, as indicated by a front-light auto-exposure convergence curve 105, when the user logs in the operating system in the front-light scene, sunlight or a specific light source directly illuminates on the user's face, and can be converged to have a certain exposure brightness (which is depicted with luminance “Y” based on brightness 100) at around an eighth frame for completing a login procedure.

Still further, as indicated by a back-light auto-exposure convergence curve 103, when the user logs in the operating system in the back-light scene, lights illuminate on the user from the back of the user, and may be directed onto the camera. The back light may cause overexposure or underexposure when the camera is used to capture the user's face. At this time, most of the user's facial features will be obscured until auto-exposure convergence of the camera is completed. Therefore, a longer time is required for the user to log in the operating system since normal login can be achieved only when the operating system correctly recognizes the facial features. The back-light auto-exposure convergence curve 103 shows that the operating system correctly recognizes the facial features at around a fourteenth frame. Further, as indicated by an outdoor auto-exposure convergence curve 101, the time for auto-exposure convergence of a user image taken by an IR camera will be affected since IR composition of an outdoor light is great. The outdoor auto-exposure convergence curve 101 shows that the auto-exposure convergence is completed at around a ninth frame. An indoor auto-exposure convergence curve 107 shows that the auto-exposure convergence can be quickly accomplished since an indoor light is relatively simple and is with less impact of infrared light. This example shows that the auto-exposure convergence curve has a stable beginning.

### SUMMARY OF THE DISCLOSURE

In response to the above-referenced technical inadequacies, the present disclosure provides an intelligent method for logging in an operating system through artificial intelligence and a system thereof, so as to effectively shorten an automatic exposure process in a procedure of using a biometric image to log in the operating system.

In the intelligent method, a color camera is used to capture color images, and brightness information can be retrieved from the color images. A scene-prediction model is operated to predict a scene and obtain an exposure setting corresponding to the scene according to the brightness information. Next, an IR camera is activated to capture infrared images according to the exposure setting. The system then relies on a biometric image extracted from these infrared images to conduct identification for logging in the operating system.

The intelligent method for logging in the operating system is operated in the system. In a booting procedure after the system is started up, the color camera is activated to capture the color image for completing the process of predicting the scene and obtaining the exposure setting before the IR camera is activated.

Further, the system uses a machine vision processor to determine the brightness information according to the color image, and uses the scene-prediction model to identify whether the scene is an indoor scene, a front-light scene, a back-light scene, an outdoor scene, or a low-light scene. The scene can be referred to for calculating a corresponding weight value. The weight value is used to map a color exposure setting to an IR exposure setting for obtaining the exposure setting. The exposure setting is a product of an exposure time and a gain that are adapted to the scene. The IR camera generates the infrared image according to the IR exposure setting.

Further, after the exposure setting corresponding to the scene is obtained, the IR camera is activated, and an IR light source is also driven to illuminate a user, so as to capture continuous frames having a series of bright and dark frames. The exposure setting can take effect on a first bright frame of the continuous frames, so as to obtain the biometric image having an appropriate exposure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting conventional automatic exposure convergence curves for scenes under various ambient lights;

FIG. 2 is an exemplary diagram depicting a circumstance of performing an intelligent method for logging in an operating system of the present disclosure;

FIG. 3 is a flowchart illustrating a process of a firmware in a camera system that performs the intelligent method for logging in the operating system according to one embodiment of the present disclosure;

FIG. 4 is a flowchart illustrating the intelligent method for logging in the operating system according to one embodiment of the present disclosure;

FIG. 5 is a schematic diagram depicting continuous frames generated in the intelligent method for logging in the operating system according to one embodiment of the present disclosure;

FIG. 6 is a schematic diagram depicting training of a scene-prediction model according to one embodiment of the present disclosure;

FIG. 7 is a schematic diagram depicting a mapping relationship between color exposure settings and IR exposure settings according to one embodiment of the present disclosure;

FIG. 8 is an exemplary diagram illustrating an auto-exposure convergence curve adopted in the intelligent method for logging in the operating system according to one embodiment of the present disclosure; and

FIGS. 9(A) and 9(B) respectively show two diagrams of frames of a user to be captured before and after performing the intelligent method for logging in the operating system according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to improve an auto-exposure convergence speed when using biometric image identification to log in a system under different scenes with various ambient lights, the present disclosure provides an intelligent method for logging in an operating system and a system. In certain embodiments of the intelligent method for logging in the operating system, a machine-learning algorithm in the method is used to learn a large amount of images that are used to determine various scenes, so as to train a scene-prediction model. In a booting procedure of a computer system, an image-processing method is operated in a background procedure for obtaining ambient color information, and the scene-prediction model is used for predicting a scene type. The scene can be a low-light scene, a back-light scene, a front-light scene, an indoor scene, an outdoor scene, or the like. An exposure setting adapted to a current scene can be obtained before a system login procedure is performed. After that, a biometric image with an appropriate exposure can be obtained. Accordingly, a technical effect of quickly completing a login procedure that is performed in the operating system at the beginning under different scenes with various ambient lights can be achieved. Preferably, the identification and the login procedure can be completed when a camera takes a first frame of a user.

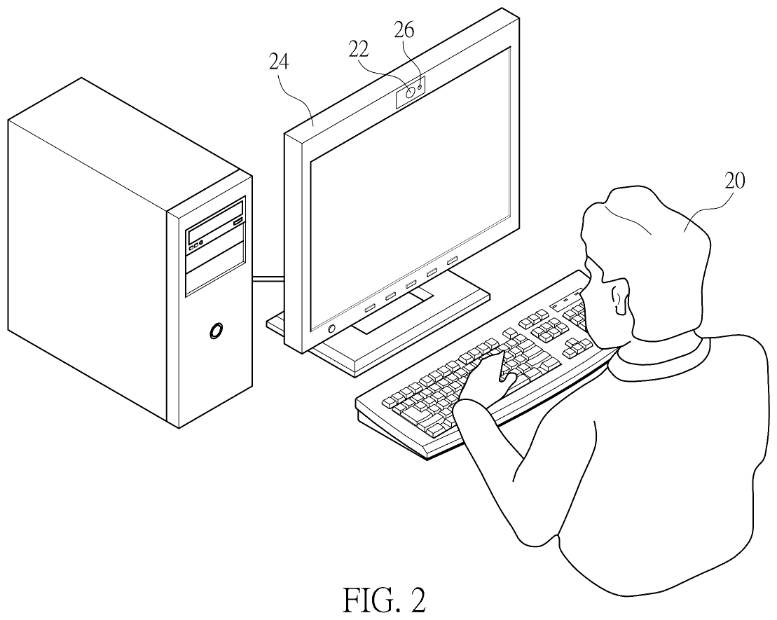

The system performing the intelligent method for logging in the operating system can be a computer operating system that allows the user to log in through a facial image recognition technology. Reference is made to FIG. 2, which is a schematic diagram depicting a circumstance of performing the intelligent method for logging in the operating system according to one embodiment of the present disclosure.

An operating system is operated in a computer system 24. When the operating system waits for a user 20 to log in, a light source 26 of a camera system is driven to assist in illuminating the user 20, and a camera 22 of the camera system is driven to capture an image and detect whether or not any person is in front of a computer console. When the user 20 is detected to be in front of the computer console, the computer system 24 immediately initiates a login procedure for the operating system, and drives the camera 22 of the camera system to capture a facial image of the user 20. After continuous images are obtained, these images are provided for the computer system 24 to perform facial recognition, and the user 20 can successfully log in the computer system 24 after comparison of the facial features.

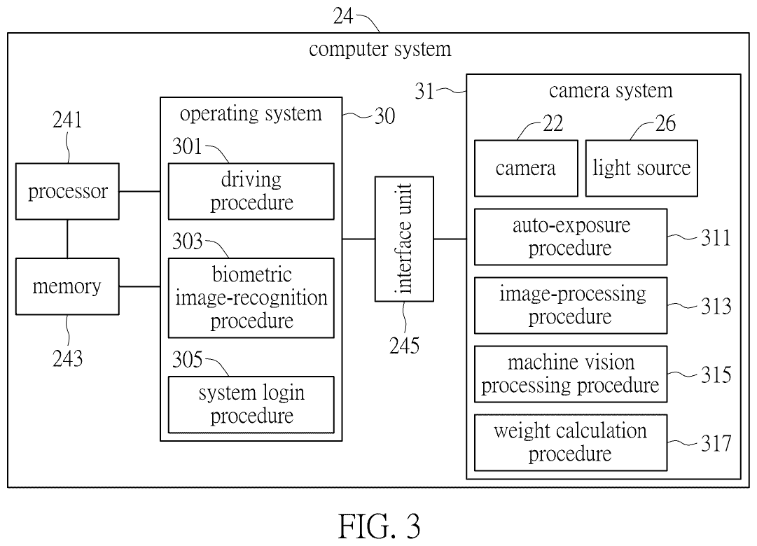

The computer system 24 can be any system that relies on biometric image recognition to perform the login procedure. Reference is made to FIG. 3, in which main circuits of the computer system 24 are shown. The main circuits of the computer system 24 include a processor 241 and a memory 243 that are used to operate an operating system 30. The computer system 24 essentially includes the operating system 30, a camera system 31, and an interface unit 245 that is used to interconnect the operating system 30 and the camera system 31. Main procedures operated in the operating system 30 include a driving procedure 301 that is used to drive the camera 22 and the light source 26 of the camera system 31, a biometric image-recognition procedure 303 that is used to extract biometric images and conduct identification, and a system login procedure 305.

Further, the camera system 31 operates an auto-exposure procedure 311 that also includes an image-processing procedure 313, a machine vision processing procedure 315, and a weight calculation procedure 317. The image-processing procedure 313 is used to process image signals generated by the camera 22. The image signals are, for example, red, green, and blue channel values. The machine vision processing procedure 315 is executed by a machine vision processor (MVP) to obtain an image within a designated zone that is provided for the system to perform a login procedure. Color information and brightness information are also retrieved from the image and provided for the scene-prediction model to predict the scene, so as to determine the exposure setting. The exposure setting includes a product of an exposure time and gain (EtGain). Further, the exposure setting obtained by analyzing a color image is mapped to an IR exposure setting. After that, when the scene determined based on information of a bright portion of the biometric image of a user is used to obtain a corresponding exposure setting, the weight calculation procedure 317 is used to obtain a weight value corresponding to the scene. One of the objectives of the method is to calculate the weight value with respect to the scene, so as to adaptively calculate a product of the exposure time adapted to the scene and the gain.

It should be noted that the exposure time is, for example, a shutter speed of the camera when an image is taken, and an exposure value and a gain value are both data read from a photosensitive element of the camera. The exposure value and the gain value are factors affecting whether an image to be taken by the camera is overexposed or underexposed. Thus, in the auto-exposure procedure 311, an exposure setting corresponding to a predicted scene before the login procedure is performed can be obtained, or a product (EtGain) of the exposure time and the gain that are adjusted by weights can be obtained, so that the biometric image can be used for conducting identification and performing the login procedure.

According to one embodiment of the present disclosure, the camera 22 includes a color camera and an IR camera that are respectively used for capturing a color image (which is used for obtaining brightness information) and an infrared biometric image. The light source 26 is, for example, an IR light source (e.g., IR LED) that is provided for the IR camera to capture a subject for obtaining continuous bright and dark frames. The computer system 24 drives the light source 26 of the camera system 31 to be turned on or off by the driving procedure 301. The camera 22 can continuously take the bright frames and the dark frames. It should be noted that, taking the IR light source as an example, the computer system 24 can obtain continuous IR bright frames and IR dark frames. The bright frame contains energy of the infrared light reflected by an object (e.g., the user or his face) when the infrared light is emitted to the object and energy of the infrared light received from an external source. The dark frame only contains the energy of the infrared light received from the external source.

When a login procedure (e.g., Windows® Hello) 305 of the operating system 30 receives frame pairs that include the bright and dark frames captured by the IR camera, the auto-exposure procedure 311 executed by the operating system 30 performs subtraction of the bright frame and the dark frame, so as to acquire a subtracted frame of the energy of the infrared light reflected by the object when the infrared light is emitted to the object (e.g., the user or his face). The subtracted frame is referred to for the operating system 30 to perform the biometric image-recognition procedure 303. In the biometric image-recognition procedure 303, features extracted from the subtracted frame are compared with biometric features that are registered in the operating system 30 in advance and are stored in a memory 243. Therefore, whether or not the instant biometric features (e.g., the facial features) of the user are consistent with the biometric features that are registered in the operating system 30 in advance can be determined. The user can successfully log in the computer system 24 if the instant biometric features are determined to be consistent with the registered biometric features in the login procedure 305.

It should be noted that, in addition to the IR camera having an infrared photosensitive element, the system uses the color camera to capture the color image containing biometric features. The color information can be extracted from the biometric features, and can be used in other applications. For example, the color information can be used to achieve facial anti-spoofing that is performed after a procedure of recognizing the biometric features of the user according to the infrared images captured by the IR camera has been accomplished.

Compared to the conventional technology that requires a longer auto-exposure convergence time for logging in the system through biometric image identification due to various ambient lights, the intelligent method for logging in the operating system provided by the present disclosure already acquires an exposure setting adapted to a related scene before using a camera to take a biometric image, so that the exposure setting takes effect on a first bright IR frame captured by the camera. Therefore, the method allows a user to quickly log in the operating system.

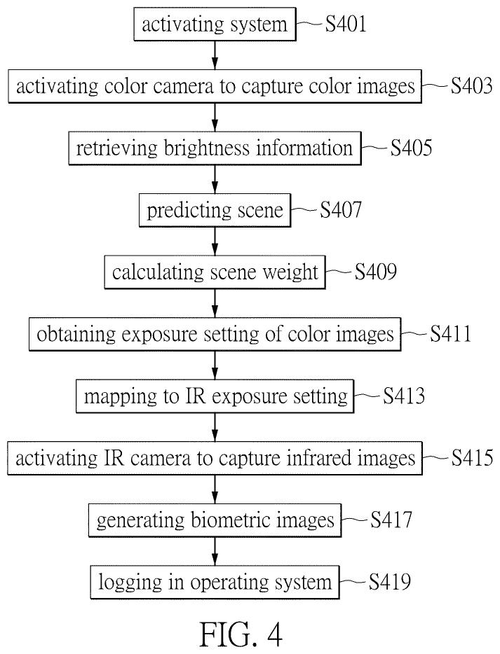

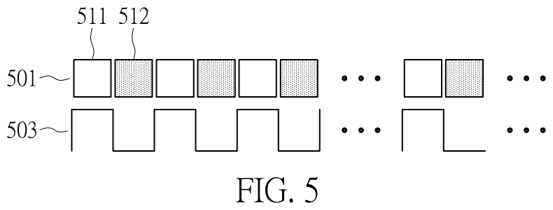

Reference is made to FIG. 4, which is a flowchart illustrating the intelligent method for logging in the operating system. Reference is also made to FIG. 5, which is a schematic diagram depicting continuous frames generated in the intelligent method according to one embodiment of the present disclosure.

After activation of the computer system, a booting procedure is executed (step S401), in which a processing circuit accomplishing initialization of the computer system activates a color camera to capture color images in a background process (step S403). After that, an image-processing technology is incorporated to retrieve brightness information from the color images (step S405). In the meantime, a scene-prediction model is applied for predicting a scene where a user logs in the computer system and a corresponding exposure setting according to the brightness information (step S407). In certain embodiments, a machine vision processor is used to determine brightness information based on the color image, and the scene-prediction model is used to identify the scene (which can be an indoor scene, a front-light scene, a back-light scene, an outdoor scene, or a low-light scene). Images can be captured based on the predicted scene and the corresponding exposure setting. In a practical situation where the intelligent method for logging in the operating system is performed, the exposure setting to be determined according to the brightness information and the exposure setting required by the IR camera for capturing infrared images are different from each other in different scenes under various ambient lights. As such, different weight values corresponding to the various scenes are required to be calculated in the intelligent method of the present disclosure (step S409).

When the system obtains the exposure setting for the color images (step S411), the exposure setting can be mapped to an IR exposure setting according to a corresponding weight value (step S413), and then the login procedure for the operating system is performed. In the login procedure, the IR camera is activated to capture infrared images according to the IR exposure setting (step S415). In an instance, the IR camera is used to capture IR images of the user who wants to log in the operating system. Accordingly, one of the infrared images of the user is used as a biometric image with an appropriate exposure value (step S417), and is used for conducting identification of the user. The user can log in the operating system after the identification is accomplished (step S419).

When the operating system initiates the login procedure and activates the IR camera to capture images of the user, the operating system drives an IR light source of the camera system to be turned on or off according to high and low levels of a driving pulse 503 of the IR light source (as shown in FIG. 5). At the same time, the IR camera of the camera system is driven to capture images of the user for retrieving a biometric image. The continuous IR frames 501 having bright and dark frames are formed. In the diagram, the continuous IR frames 501 are formed by continuous IR dark frames and IR bright frames. The camera system controls a switch of the IR light source to be turned on at a first time, so as to obtain a first bright frame 511 and then a first dark frame 512. Accordingly, multiple bright-dark frame pairs (such as bright-dark-bright-dark frames) are formed. The IR exposure setting will be taken effect on the first bright frame 511, so as generate a biometric image with an appropriate exposure value.

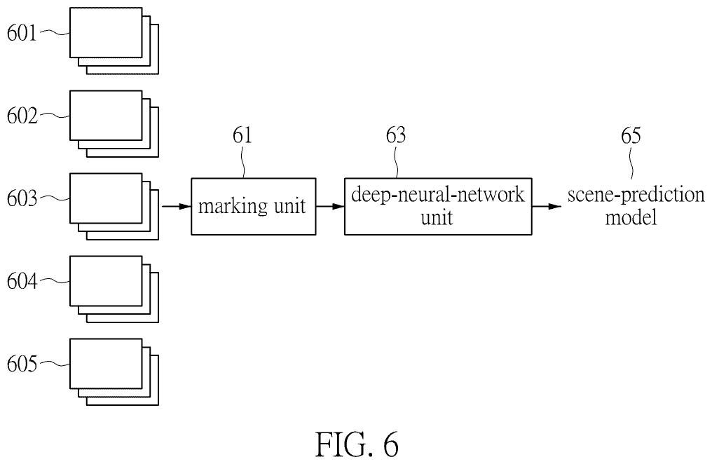

It should be noted that a common computer system uses a color camera to capture color images, but the color images are unable to reflect IR composition of lights of the scene. Hence, whether the light source is sunlight or an indoor fluorescent tube is not distinguishable, and it is also difficult to distinguish whether the instant scene includes a front light having sunlight composition or a back light by a brightness-statistical method. Therefore, the intelligent method for logging in the operating system of the present disclosure uses an artificial intelligence technology to establish a scene-prediction model. According to one embodiment of the present disclosure, the scene-prediction model can be an intelligent model that is trained by a data-driven scheme and is able to recognize various scenes. FIG. 6 is a schematic diagram illustrating a framework for training the scene-prediction model according to one embodiment of the present disclosure.

When a training set is established in a model-training phase, a large amount of color images relating to various scenes (such as outdoor scene images 601, back-light scene images 602, front-light scene images 603, indoor scene images 604, and low-light scene images 605 shown in the diagram) are firstly obtained. However, actual implementations are not limited to the above-mentioned scenes. Next, a marking unit 61 is used to mark a label on the images corresponding to the specific scenes by a software means, so as to establish the training set to be inputted to a deep-neural-network unit 63.

According to one embodiment of the present disclosure, the deep-neural-network unit 63 can use convolutional neural networks (CNN) to learn image features in the various scenes by a supervised learning method and perform categorization on the images. A scene-prediction model 65 adapted to various scenes is established. After that, during a model-prediction phase (referring to step S405 of FIG. 4), the scene-prediction model 65 is applied to a specific scene for calculating confidences of the images of the scene, so as to acquire a scene type with the highest confidence. Accordingly, scene prediction can be accomplished.

According to one embodiment of the present disclosure, the intelligent method for logging in the operating system can be implemented on edge devices with lower computing power. For example, the scene-prediction model 65 used in the intelligent method for logging in the operating system is based on a network framework of a lightweight convolutional neural network, such as Mobilenet-V2. Specifically, a depthwise separable convolution method is used to compress a model and reduce parameters for improving a computing speed, so that the scene-prediction model 65 is applicable to the edge device with an embedded system due to the fewer model parameters. For example, the embedded system is the system that adopts the above-mentioned machine vision processor.

After the scene-prediction model 65 is used to predict a present scene, the camera system relies on the brightness information extracted from the color images of the scene to acquire an exposure setting for the color images. For example, in step S411 of FIG. 4, the exposure setting for the color images is mapped to an IR exposure setting based on a weight value before the IR camera is activated, such as in step S413 of FIG. 4.

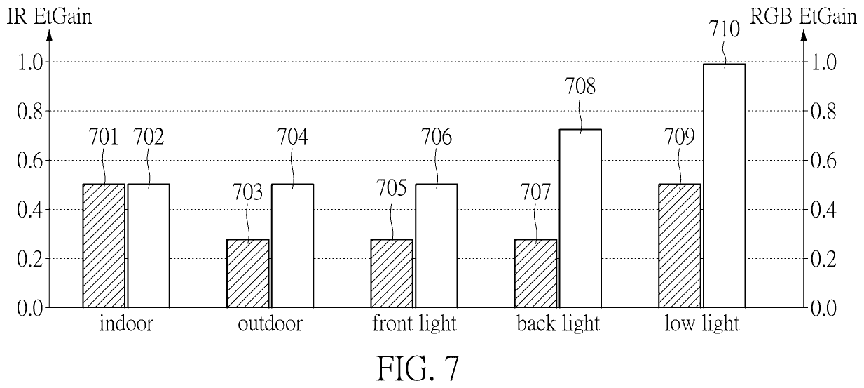

However, the exposure setting for the color images and the exposure setting for the infrared images are not linearly related for mapping. Further, the exposure settings have different mapping relations in different scenes. Referring to FIG. 7, a technical theory in which a product (RGB EtGain) of a mapping exposure time and gain is a product (IR EtGain) of an exposure time of an infrared light and gain is illustrated.

FIG. 7 shows the exposure settings for color images in various scenes, such as the products of the exposure times and gains. Here, a right vertical axis denotes the “RGB EtGain”, a left vertical axis denotes the “IR EtGain” of the IR exposure setting, and a horizontal axis marks various scenes that include an indoor scene, a front-light scene, a back-light scene, an outdoor scene, and a low-light scene. After the various scenes are predicted, IR exposure setting values 701, 703, 705, 707, and 709 and color exposure setting values 702, 704, 706, 708, and 710 corresponding to the scenes are obtained. It should be noted that numerical values of the exposure settings are normalized to a range of from 0 to 1.

In an exemplary example, the color exposure setting value (e.g., marked as “RGB EtGain”) and the IR exposure setting value (e.g., marked as “IR EtGain”) are linearly related in an indoor scene due to absence of sunlight. Referring to FIG. 7, a ratio of the IR exposure setting value 701 and the color exposure setting value 702 is close to 1. In an outdoor scene under sunlight, since the sunlight provides extra infrared light energy, the IR exposure setting value 703 required by the IR camera is smaller than the color exposure setting value 704. In a front-light scene, since the front light (e.g., sunlight) provides extra infrared light energy, the IR exposure setting value 705 required by the IR camera is smaller than color exposure setting value 706. It should be noted that a ratio between the IR exposure setting value 705 and the color exposure setting value 706 is similar to a ratio of the outdoor scene.

In a back-light scene, even though the sunlight provides extra infrared light energy, the face of the user may be underexposed. Compared with the IR exposure setting value 707 required by the IR camera, the color exposure setting value 708 requires a larger numerical value for increasing brightness of the face of the user. In a low-light scene, even though the face of the user may be underexposed, the color exposure setting value 710 has a greater impact, and requires a larger exposure setting value. Since there is no extra infrared energy provided by the sunlight, the IR exposure setting value 709 also requires a larger numerical value than those of other scenes (such as the back-light scene).

Referring to FIG. 7, the color exposure setting values and the IR exposure setting values have different levels of ratios in different scenes, and the weight values required for mapping are also different. The relational expression for considering the weight value is such as: W_{Indoor} (indoor scene weight)>W_{outdoor} (outdoor scene weight)≥W_{frontlight} (front-light scene weight)>W_{lowlight} (low-light scene weight)>W_{backlight} (back-light scene weight).

In different scenes (e.g., the indoor scene, the outdoor scene, the front-light scene, the back-light scene, and the low-light scene), the relational expressions illustrating the exposure settings for the color images mapped to the IR exposure settings are as shown in Equations (1) to (5).

$$IR {EtGain}_{indoor} = RGB {EtGain}_{Indoor} \times {W}_{Indoor} ; \qquad Equation ( 1 )$$

$$IR Et {Gain}_{o utdoor} = RGB {EtGain}_{outdoor} \times {W}_{outdoor} ; \qquad Equation ( 2 )$$

$$IR Et {Gain}_{frontlight} = RGB {EtGain}_{frontlight} \times {W}_{frontlight} ; \qquad Equation ( 3 )$$

$$IR {EtGain}_{backlight} = RGB {EtGain}_{backlight} \times {W}_{backlight} ; \qquad Equation ( 4 )$$

$$IR {EtGain}_{lowlight} = RGB {EtGain}_{lowlight} \times {W}_{lowlight} . \qquad Equation ( 5 )$$

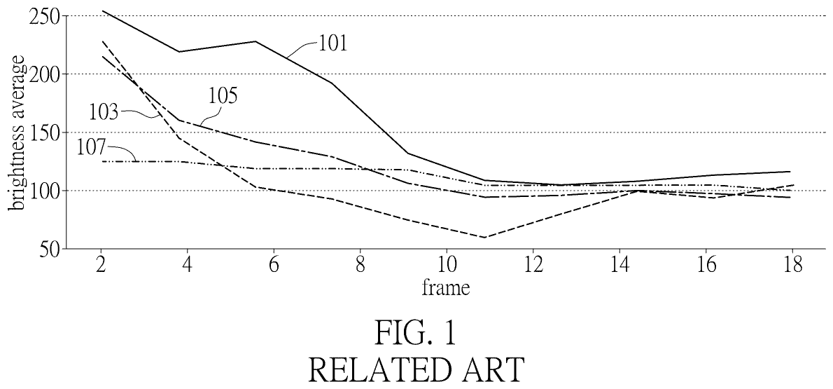

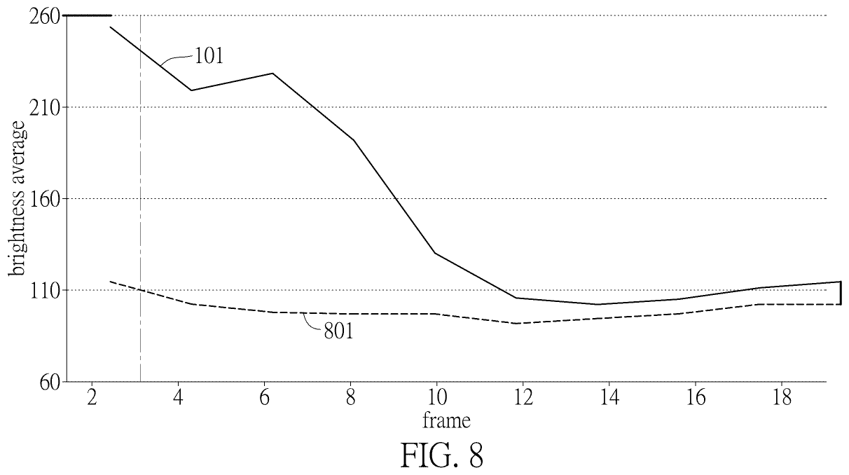

According one of the embodiments of the intelligent method for logging in the operating system of the present disclosure, the procedure for acquiring the auto-exposure value for the biometric image of the user can be effectively converged by the method. Reference is made to FIG. 8, which schematically depicts an auto-exposure convergence curve of an outdoor scene. The curve diagram shows changes of average brightness values of continuous frames captured in the outdoor scene. The curve diagram includes the original outdoor auto-exposure convergence curve 101 (as shown in FIG. 1) before the intelligent method for logging in the operating system is performed, in which the biometric image available for identifying the user is obtained at a tenth frame as the auto-exposure convergence is completed. By performing the intelligent method for logging in the operating system to acquire the exposure value (i.e., the product of the exposure time and the gain) for a corresponding scene, the purpose of quickly obtaining the automatic exposure value can be achieved, thereby obtaining an improved auto-exposure convergence curve 801. Particularly, an appropriate exposure setting can be obtained by predicting the corresponding scene before the login procedure. Therefore, the login procedure can be accomplished when a first bright frame is obtained after the IR camera is activated.

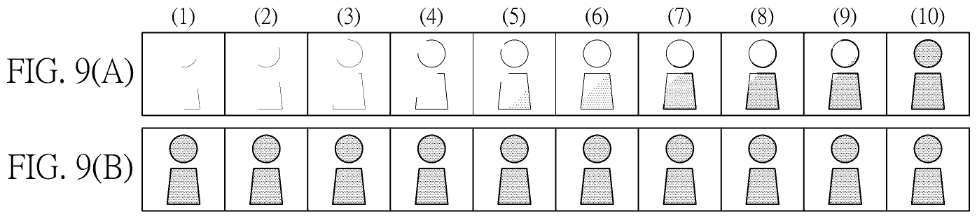

FIGS. 9(A) and 9(B) are schematic diagrams illustrating the user's images before and after the intelligent method for logging in the operating system is performed.

FIG. 9(A) shows the continuous frames of the user to be captured before the intelligent method is performed. In FIG. 9(A), a fully white user image is gradually changed to a clearest image at the tenth frame through a convergence process of the auto-exposure value. In FIG. 9(B), after the intelligent method is performed, the biometric image with an appropriate exposure value used for user identification can be obtained at a first frame.

In conclusion, according to the embodiments of the intelligent method for logging in the operating system and the system provided by the present disclosure, the intelligent method uses an artificial intelligence technology, and operates a color camera and a machine vision processor in the background. Before an IR camera is activated, brightness information of a current scene can be detected in advance, and a scene-prediction model is used to identify a type of the scene. In this way, the intelligent method can be adapted to various scenes for obtaining an appropriate exposure setting, and the purpose of quickly logging in the operating system can be achieved in a login procedure. More particularly, the exposure setting applicable to the current scene can be obtained before a first frame is retrieved. Therefore, in the intelligent method, the system can receive an infrared image having an appropriate brightness to accomplish the login procedure when the IR camera is activated to obtain a first frame pair.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An intelligent method for logging in an operating system, comprising:
capturing a color image, and retrieving brightness information of the color image;
operating a scene-prediction model to predict a scene according to the brightness information and obtain an exposure setting corresponding to the scene;
activating an IR camera to generate an infrared image according to the exposure setting; and
using a biometric image extracted from the infrared image to log in the operating system after identification is processed.

2. The intelligent method according to claim 1, wherein, after the exposure setting corresponding to the scene is obtained, the IR camera is activated to capture continuous frames of a user, and the exposure setting takes effect on a first bright frame of the continuous frames, so as to obtain the biometric image having an appropriate exposure.

3. The intelligent method according to claim 2, wherein, when the IR camera is activated, an IR light source is driven to illuminate the user, so as to obtain the continuous frames having a series of bright and dark frames.

4. The intelligent method according to claim 1, wherein the intelligent method is operated in a system; wherein, in a booting procedure after the system is started up, a color camera is activated to capture the color image for completing the process of predicting the scene and obtaining the exposure setting before the IR camera is activated.

5. The intelligent method according to claim 4, wherein the system uses a machine vision processor to determine the brightness information according to the color image, and uses the scene-prediction model to identify whether the scene is an indoor scene, a front-light scene, a back-light scene, an outdoor scene, or a low-light scene.

6. The intelligent method according to claim 5, wherein the scene is referred to for calculating a corresponding weight value that is used to map a color exposure setting to an IR exposure setting, so that the exposure setting is obtained, and the IR camera captures the infrared image according to the IR exposure setting.

7. The intelligent method according to claim 6, wherein the exposure setting is a product of an exposure time adapted to the scene and a gain.

8. The intelligent method according to claim 7, wherein, after the exposure setting corresponding to the scene is obtained, the IR camera is activated to capture continuous frames of a user, and the exposure setting takes effect on a first bright frame of the continuous frames, so as to obtain the biometric image having an appropriate exposure.

9. The intelligent method according to claim 8, wherein, when the IR camera is activated, an IR light source is driven to illuminate the user, so as to obtain the continuous frames having a series of bright and dark frames.

10. A system for performing an intelligent method for logging in an operating system, comprising:
a computer system, wherein the computer system includes a camera system, and the camera system includes a color camera, an IR camera, and an IR light source;
wherein the computer system operates the operating system, and the intelligent method that is performed includes:
using the color camera to capture a color image, and retrieving brightness information of the color image;
operating a scene-prediction model to predict a scene according to the brightness information and an exposure setting corresponding to the scene;
activating the IR camera to generate an infrared image according to the exposure setting; and
using a biometric image extracted from the infrared image to log in the operating system after identification is processed.

11. The system according to claim 10, wherein, in a booting procedure after the system is started up, the color camera is activated to capture the color image for completing the process of predicting the scene and obtaining the exposure setting before the IR camera is activated.

12. The system according to claim 11, wherein, after the exposure setting corresponding to the scene is obtained, the IR camera is activated to capture continuous frames of a user, and the exposure setting takes effect on a first bright frame of the continuous frames, so as to obtain the biometric image having an appropriate exposure.

13. The system according to claim 12, wherein, when the IR camera is activated, an IR light source is driven to illuminate the user, so as to obtain the continuous frames having a series of bright and dark frames.

14. The system according to claim 13, wherein the system controls a switch of the IR light source to be turned on at a first time, so as to obtain the first bright frame.

15. The system according to claim 11, wherein the system uses a machine vision processor to determine the brightness information according to the color image, and uses the scene-prediction model to identify whether the scene is an indoor scene, a front-light scene, a back-light scene, an outdoor scene, or a low-light scene.

16. The system according to claim 15, wherein the scene is referred to for calculating a corresponding weight value that is used to map a color exposure setting to an IR exposure setting, so that the exposure setting is obtained, and the IR camera captures the infrared image according to the IR exposure setting.

17. The system according to claim 16, wherein the exposure setting is a product of an exposure time adapted to the scene and a gain.

18. The system according to claim 17, wherein, after the exposure setting corresponding to the scene is obtained, the IR camera is activated to capture continuous frames of a user, and the exposure setting takes effect on a first bright frame of the continuous frames, so as to obtain the biometric image having an appropriate exposure.

19. The system according to claim 18, wherein, when the IR camera is activated, an IR light source is driven to illuminate the user, so as to obtain the continuous frames having a series of bright and dark frames.

20. The system according to claim 19, wherein the system controls a switch of the IR light source to be turned on at a first time, so as to obtain the first bright frame.
